(19) United States
(12) Patent Application Publication
(10) Pub. No.: US 2018/0255769 A1
(43) Pub. Date: Sep. 13, 2018

(54) LOW VOLATILITY HERBICIDAL COMPOSITIONS

(71) Applicant: RHODIA OPERATIONS, Paris (FR)

(72) Inventors: Laurianne Françoise Marie MOITY, Courbevoie (FR); Monique Martine Françoise ADAMY, Asnièressur- Seine (FR)

(21) Appl. No.: 15/915,610

(22) Filed: Mar. 8, 2018

Related U.S. Application Data
(60) Provisional application No. 62/468,614, filed on Mar. 8, 2017.

(30) Foreign Application Priority Data
Mar. 8, 2017 (EP) 17159844.4

(51) Int. Cl. A01N 25/08; A01N 37/40; A01N 25/04

(52) U.S. Cl. CPC A01N 25/08; A01N 25/04; A01N 37/40

(57) ABSTRACT

The present invention relates to low volatility herbicidal compositions comprising at least one auxin herbicide and at least one cationic polysaccharide derivative.

The present invention relates to low volatility herbicidal compositions comprising at least one auxin herbicide and at least one cationic polysaccharide derivative.

The invention further relates to methods for preparing and using such low volatility herbicidal compositions, including methods of reducing the volatility of an auxin herbicide and methods of reducing off-site movement of an auxin herbicide.

Auxin herbicides are a well-known class of herbicides used to kill weeds by inducing hormonal effects on sprayed plants. They are thus commonly used to control auxin-susceptible plant growth. Typical representatives of auxin herbicides include 2,4-D (2,4-dichlorophenoxyacetic acid) and dicamba (3,6-dichloro-2-methoxybenzoic acid).

Drift, but most importantly volatility, are problems frequently faced when using this class of herbicides.

Spray drift is defined by the Environmental Protection Agency as the movement of pesticide dust or droplets through the air at the time of application or soon thereafter, to any site other than the area intended.

As for volatilization, it occurs when pesticide surface residues change from a solid or liquid to a gas or vapor after an application of a pesticide has occurred. Once airborne, volatile pesticides can move long distances off site (and in particular longer distances compared to spray drift).

Non-target plant damage associated with auxin herbicide volatilization is a major concern for crop growers nowadays. As a matter of fact, unintentional application of auxin herbicides to a sensitive plant generally causes severe injury, loss of yield, and even death of the non-target plants.

This is the reason why there is an increasing demand today for low volatility auxin herbicide compositions.

Impact of the counter-ion has already been investigated and it has been demonstrated, for instance, that the diglycolamine salt of dicamba exhibits a lower volatility than the dimethylamine salt of dicamba. Also, the addition of specific polybasic polymers to dicamba formulations has been reported.

An object of the present invention is to provide an adjuvant which is useful for reducing the volatility and off-target movement of auxin herbicides.

Another object of the present invention is to provide auxin herbicide compositions having reduced volatility relative to currently available compositions, and preferably reduced-volatility compositions that exhibit no significant reduction in herbicidal effectiveness relative to currently available compositions.

It has been discovered unexpectedly that the addition of a sufficient amount of a polysaccharide derivative as defined according to the invention to an auxin herbicide compositions results in a reduced auxin herbicide volatility upon application relative to an otherwise identical composition lacking the polysaccharide derivative as defined according to the invention.

Specifically, the compositions of the invention comprise, in addition to the auxin herbicide, at least one polysaccharide derivative, wherein said polysaccharide derivative is a cationic polysaccharide derivative, in an amount sufficient to reduce the volatility of the auxin herbicide relative to an otherwise identical composition lacking said polysaccharide derivative.

In one aspect, the present invention provides a method of reducing the volatility of an auxin herbicide, the method comprising the step of contacting the auxin herbicide with a volatility-lowering effective amount of at least one cationic polysaccharide derivative, thereby reducing the volatility of the auxin herbicide.

In another aspect, the present invention provides a method of reducing off-site movement of an auxin herbicide following application to the foliage of auxin-susceptible plants of a herbicidal mixture comprising an auxin herbicide, the method comprising:

i/ preparing an herbicidal application mixture comprising an auxin herbicide; at least one cationic polysaccharide derivative; and a solvent, for instance water; and

ii/ applying the herbicidal mixture to the foliage of the auxin-susceptible plants.

In another aspect, the present invention provides an herbicidal composition comprising:
at least one auxin herbicide, and
at least one cationic polysaccharide derivative.

In another aspect, the present invention provides a process for preparing a diluted auxin herbicide spray formulation exhibiting reduced off-site movement of said auxin herbicide comprising introducing a cationic polysaccharide derivative to said diluted agrochemical spray formulation.

In another aspect, the present invention provides a method for treating an agricultural field comprising spraying the field with such a diluted auxin herbicide spray formulation.

Advantageously, it is believed that the compositions of the present invention provide enhanced protection from off-target crop injury while maintaining comparable herbicidal efficacy on auxin-susceptible plants located in the target area.

The auxin-susceptible plants can be weeds or crop plants. Crop plants include, for example, vegetable crops, grain crops, flowers, and root crops. Crop plants further encompass hybrids, inbreds, and transgenic or genetically modified plants.

In particular, it is believed that the addition of the polysaccharide derivative as defined according to the invention, preferably at the loading values discussed below, to the herbicidal compositions of the present invention effectively reduces auxin herbicide volatility and the associated crop injury without significantly reducing auxin herbicide effectiveness.

Impact on the auxin herbicide volatility can be measured by conventional means known to those skilled in the art.

For instance, volatilization of an auxin herbicide can be assessed as follows: an auxin herbicide composition is heated, causing the auxin herbicide to volatilize from said composition into the gas phase. Weight of residual auxin herbicide composition is recorded against time (through thermogravimetric analyses), allowing indirect measurement of volatilization of the auxin herbicide.

Auxin Herbicide

The term “auxin herbicide” refers to a herbicide that functions as a mimic of an auxin plant growth hormone, thereby affecting plant growth regulation. Examples of auxin herbicides that are suitable for use in the herbicidal compositions of the present invention include, without limitation, benzoic acid herbicides, phenoxy herbicides, pyridine carboxylic acid herbicides, pyridine oxy herbicides, pyrimidine carboxy herbicides, quinoline carboxylic acid herbicides, and benzothiazole herbicides.

According to anyone of the invention embodiments, the auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-quinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

According to anyone of the invention embodiments, the auxin herbicide is dicamba, or an agriculturally acceptable salt or ester thereof, for instance dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt or dicamba dimethylamine salt.

According to another one of the invention embodiments, the herbicidal composition comprises at least 2,4-D, or an agriculturally acceptable salt or ester thereof.

For instance, a herbicidal composition of the invention may comprise a 2,4-D salt selected in the group consisting of: the choline, dimethylamine, and isopropylamine salts, and combinations thereof.

For instance, a herbicidal composition of the invention may comprise a 2,4-D ester selected in the group consisting of: the methyl, ethyl, propyl, butyl (2,4-DB), and isooctyl esters, and combinations thereof.

Polysaccharide Derivative

Suitable, non limitative, examples of polysaccharide polymers include, for example, galactomannans, chitosan, pectin, alginate, hyaluronic acid, agar, xanthan, dextrin, starch, cellulose, amylose, amylopectin, alternan, gellan, levan, mutan, dextran, pullulan, fructan, gum arabic, carrageenan, glycogen, glycosaminoglycans, murein, xyloglucans and bacterial capsular polysaccharides.

In one embodiment, the polysaccharide of the invention include, for example, galactomannans such as guars, including guar derivatives, xanthans, polyfructoses such as levan, starches, including starch derivatives, such as amylopectin, xyloglucans such as tamarind gum and tamarind gum derivatives such as hydroxypropyl tamarind gum, and cellulose, including cellulose derivatives, such as methylcellulose, ethylcellulose, carboxymethylcellulose, hydroxyethylcellulose, cellulose acetate, cellulose acetate butyrate, and cellulose acetate propionate.

Galactomannans are polysaccharides consisting mainly of the monosaccharides mannose and galactose. The mannose-elements form a chain consisting of many hundreds of (1,4)-ß-D-mannopyranosyl-residues, with 1,6 linked-D-galactopyranosyl-residues at varying distances, dependent on the plant of origin. Naturally occurring galactomannans are available from numerous sources, including guar gum, guar splits, locust bean gum and tara gum, flame tree gum and cassia gum.

Additionally, galactomannans may also be obtained by classical synthetic routes or may be obtained by chemical modification of naturally occurring galactomannans.

Guar gum refers to the mucilage found in the seed of the leguminous plant Cyamopsis tetragonolobus. The water soluble fraction (85%) is called “guaran,” which consists of linear chains of (1,4)-.β-D mannopyranosyl units-with α-D-galactopyranosyl units attached by (1,6) linkages. The ratio of D-galactose to D-mannose in guaran is about 1:2. Guar gum typically has a weight average molecular weight of between 2,000,000 and 5,000,000 g/mol. Guars having a reduced molecular weight, such as for example, from about 50,000 to about 2,000,000 g/mol are also known.

Guar seeds are composed of a pair of tough, non-brittle endosperm sections, hereafter referred to as “guar splits,” between which is sandwiched the brittle embryo (germ). After dehulling, the seeds are split, the germ (43-47% of the seed) is removed by screening, and the splits are ground. The ground splits are reported to contain about 78-82% galactomannan polysaccharide and minor amounts of some proteinaceous material, inorganic non-surfactant salts, water-insoluble gum, and cell membranes, as well as some residual seedcoat and embryo.

Locust bean gum or carob bean gum is the refined endosperm of the seed of the carob tree, Ceratonia siliqua. The ratio of galactose to mannose for this type of gum is about 1:4. Locust bean gum is commercially available.

Tara gum is derived from the refined seed gum of the tara tree. The ratio of galactose to mannose is about 1:3. Tara gum is commercially available.

Other galactomannans of interest are the modified galactomannans, including derivatized guar polymers, such as carboxymethyl guar, carboxymethylhydroxypropyl guar, cationic guar, cationic hydroxyalkyl guar, including cationic hydroxyethyl guar, cationic hydroxypropyl guar, cationic hydroxybutyl guar and cationic higher hydroxylalkyl guars, hydroxyalkyl guar, including hydroxyethyl guar, hydroxypropyl guar, hydroxybutyl guar and higher hydroxylalkyl guars, carboxylalkyl guars, including carboxymethyl guar, carboxylpropyl guar, carboxybutyl guar, and higher carboxyalkyl guars, the hydroxyethylated, hydroxypropylated and carboxymethylated derivative of guaran, the hydroxethylated and carboxymethylated derivatives of carubin, and the hydroxypropylated and carboxymethylated derivatives of cassia-gum.

Xanthans of interest are xanthan gum and xanthan gel. Xanthan gum is a polysaccharide gum produced by Xathomonas campestris and contains D-glucose, D-mannose, D-glucuronic acid as the main hexose units, also contains pyruvate acid, and is partially acetylated.

Levan is a polyfructose comprising 5-membered rings linked through β-2,6 bonds, with branching through β-2,1 bonds. Levan exhibits a glass transition temperature of 138° C. and is available in particulate form. At a molecular weight of 1-2 million, the diameter of the densely-packed spherulitic particles is about 85 nm.

Tamarind (Tamahndus Indica) is a leguminous evergreen tall tree produced in the tropics. Tamarind gum (tamarind powder or tamarind kernel powder), a xyloglucan polysaccharide, is obtained by extracting and purifying the seed powders, obtained by grinding the seeds of tamarind. The polysaccharide molecule of the tamarind gum consists of a main linear chain of poly-glucose bearing xylose and galactoxylose substituents.

Modified celluloses are celluloses containing at least one functional group, such as a hydroxy group, hydroxycarboxyl group, or hydroxyalkyl group, such as for example, hydroxymethyl cellulose, hydroxyethyl celluloses, hydroxypropyl celluloses or hydroxybutyl celluloses.

Processes for making polysaccharide derivatives are known. In particular, processes for making derivatives of guar gum splits are generally known. Typically, guar splits are reacted with one or more derivatizing agents under appropriate reaction conditions to produce a guar polysaccharide having the desired substituent groups. Suitable derivatizing reagents are commercially available and typically contain a reactive functional group, such as an epoxy group, a chlorohydrin group, or an ethylenically unsaturated group, and at least one other substituent group, such as a cationic, nonionic or anionic substituent group, or a precursor of such a substituent group per molecule, wherein substituent group may be linked to the reactive functional group of the derivatizing agent by bivalent linking group, such as an alkylene or oxyalkylene group. Suitable cationic substituent groups include primary, secondary, or tertiary amino groups or quaternary ammonium, sulfonium, or phosphinium groups. Suitable nonionic substituent groups include hydroxyalkyl groups, such as hydroxypropyl groups. Suitable anionic groups include carboxyalkyl groups, such as carboxymethyl groups. The cationic, nonionic and/or anionic substituent groups may be introduced to the polysaccharide chains via a series of reactions or by simultaneous reactions with the respective appropriate derivatizing agents.

The polysaccharide derivative, for instance the guar derivative, may be treated with a crosslinking agent, such for example, borax (sodium tetra borate) is commonly used as a processing aid in the reaction step of the water-splits process to partially crosslink the surface of the guar splits and thereby reduces the amount of water absorbed by the guar splits during processing. Other crosslinkers, such as, for example, glyoxal or titanate compounds, are known.

In one embodiment, the polysaccharide component of the composition of the present invention is a non-derivatized polysaccharide, for instance a non-derivatized galactomannan polysaccharide, more typically a non-derivatized guar gum.

In one embodiment, the polysaccharide is a derivatized polysaccharide, for instance a derivatized galactomannan polysaccharide that is substituted at one or more sites of the polysaccharide with a substituent group that is independently selected for each site from the group consisting of cationic substituent groups, nonionic substituent groups, and anionic substituent groups.

In one specific embodiment, the polysaccharide derivative of the invention is a cationic polysaccharide derivative, that is to say a derivatized polysaccharide that is substituted at one or more sites of the polysaccharide with a substituent group that is a cationic substituent group.

In one specific embodiment, the polysaccharide derivative of the invention is a non ionic, for instance hydroxyalkylated, polysaccharide derivative, that is to say a derivatized polysaccharide that is substituted at one or more sites of the polysaccharide with a substituent group that is a non ionic, for instance hydroxyalkyl, substituent group.

In one specific embodiment, the polysaccharide derivative of the invention is an anionic polysaccharide derivative, that is to say a derivatized polysaccharide that is substituted at one or more sites of the polysaccharide with a substituent group that is an anionic substituent group.

In one embodiment, the polysaccharide derivative of the present invention is derivatized galactomannan polysaccharide, more typically a derivatized guar.

Suitable derivatized guars include, for example, hydroxypropyl trimethylammonium guar, hydroxypropyl lauryldimethylammonium guar, hydroxypropyl stearyldimethylammonium guar, hydroxypropyl guar, carboxymethyl guar, guar with hydroxypropyl groups and hydroxypropyl trimethylammonium groups, guar with carboxymethyl hydroxypropyl groups and mixtures thereof.

In another embodiment, the polysaccharide derivative of the present invention is derivatized xyloglucan polysaccharide, more typically a derivatized tamarind.

Suitable derivatized tamarinds include, for instance, hydroxypropyl tamarind gum, which may further contain substituent groups such as carboxyalkyl substituents (e.g. carboxymethyl or carboxyethyl) or hydrophobic substituents (e.g. C4-C24 linear or branched alkyl chains), such as those described in WO2016/124467, which is incorporated by reference.

The amount of derivatizing groups in a derivatized polysaccharide polymer may be characterized by the degree of substitution of the derivatized polysaccharide polymer or the molar substitution of the derivatized polysaccharide polymer.

As used herein, the terminology “degree of substitution” in reference to a given type of derivatizing group and a given polysaccharide polymer means the number of the average number of such derivatizing groups attached to each monomeric unit of the polysaccharide polymer. In one embodiment, the derivatized galactomannan polysaccharide exhibits a total degree of substitution (“DS_{T}”) of from about 0.001 to about 3.0, wherein:
DS_{T} is the sum of the DS for cationic substituent groups (“DS_{cationic}”), the DS for nonionic substituent groups (“DS_{nonionic}”) and the DS for anionic substituent groups (“DS_{anionic}”),
DS_{cationic} is from 0 to about 3, more typically from about 0.001 to about 2.0, and even more typically from about 0.001 to about 1.0,
DS_{nonionic} is from 0 to 3.0, more typically from about 0.001 to about 2.5, and even more typically from about 0.001 to about 1.0, and
DS_{anionic} is from 0 to 3.0, more typically from about 0.001 to about 2.0.

DS_{cationic}, DS_{nonionic}, and DS_{anionic} may be measured for instance by ¹H-NMR.

As used herein, the term “molar substitution” or “ms” refers to the number of moles of derivatizing groups per moles of monosaccharide units of the guar. The molar substitution can be determined by the Zeisel-GC method. The molar substitution utilized by the present invention is typically in the range of from about 0.001 to about 3.

In one embodiment, the polysaccharide derivative of the invention may further contain hydrophobic substituents.

The hydrophobic modification of a polysaccharide derivative of the invention may be obtained by the introduction of hydrophobic group.

Typical derivatizing agents bringing a hydrophobic group include C2-C24 linear or branched alkyl and alkenyl halides, or C6-C24 linear or branched alkyl and alkenyl epoxides and alkyl and alkenyl glycidyl ethers containing a C4-C24 linear or branched hydrocarbon group.

A hydrophobically modified polysaccharide derivative of the invention may have hydrophobic degree of substitution ranging from 1*10⁻⁵ to 5*10⁻¹, preferably from 1*10⁻⁴ to 1*10⁻¹.

In one embodiment, a hydrophobically modified polysaccharide derivative of the invention contains as hydrophobic groups C4-C24 alkyl chains. The hydrophobizing agent is preferably a alkyl or alkenyl glycidylether containing a C4-C24 linear or branched hydrocarbon group.

After the preparation, the polysaccharide derivative of the invention can be treated with several known reagents, for example: caustic; acids; biochemical oxidants, such as galactose oxidase; chemical oxidants, such as hydrogen peroxide; and enzymatic reagents; or by physical methods using high speed agitation machines; thermal methods; and combinations of these reagents and methods. Reagents such as sodium metabisulfite or inorganic salts of bisulfite may also be optionally included.

The treatments described here above can be also performed on the polysaccharide derivative of the invention before the derivatization process.

In a preferred embodiment, the polysaccharide derivative is a depolymerized polysaccharide derivative, which has been depolymerized by using chemicals, such as hydrogen peroxide, or cellulase enzymes.

Methods for the preparation of a polysaccharide derivative of the invention are disclosed for instance in U.S. Pat. Nos. 4,663,159; 5,473,059; 5,387,675; 3,472,840; 4,031,307; 4,959,464 and US 2010/0029929, all of which are incorporated herein by reference.

According to the present invention, the polysaccharide derivative is a cationic polysaccharide derivative.

According to anyone of the invention embodiments, the polysaccharide derivative is a cationic polysaccharide derivative having a cationic degree of substitution DScat ranging from about 0.001 to about 3.

According to anyone of the invention embodiments, the cationic polysaccharide derivative of the invention may further comprise non ionic substituent groups, for instance hydroxyalkyl groups, such as hydroxypropyl groups.

A cationic polysaccharide derivative of the invention may further have a hydroxyalkyl molar substitution ranging from 0.001 to 3.

According to anyone of the invention embodiments, the polysaccharide derivative is a cationic polysaccharide derivative having a weight average molecular weight ranging from about 2,000 to about 3,000,000 g/mol.

The weight average molecular weight of a polysaccharide derivative of the invention may be measured for instance by SEC-MALS or by using gel permeation chromatography.

According to one of the invention embodiments, the cationic polysaccharide derivative of the invention is a cationic galactomannan derivative, for instance a cationic guar derivative.

According to one of the invention embodiments, the cationic polysaccharide derivative of the invention is a cationic galactomannan derivative, for instance a cationic guar derivative, having a cationic degree of substitution DScat comprised between about 0.01 and about 0.15, for instance between about 0.05 and about 0.15 and a weight average molecular weight comprised between about 10,000 g/mol and about 2,000,000 g/mol, for instance between about 200,000 g/mol and about 1,400,000 g/mol.

According to another one of the invention embodiments, the cationic polysaccharide derivative of the invention is a cationic galactomannan derivative, for instance a cationic guar derivative, having a cationic degree of substitution DScat comprised between about 0.25 and about 0.40, and a weight average molecular weight comprised between about 200,000 g/mol and about 1,000,000 g/mol, for instance between about 250,000 g/mol and about 850,000 g/mol.

According to another one of the invention embodiments, the cationic polysaccharide derivative of the invention is a cationic galactomannan derivative, for instance a cationic guar derivative, having a cationic degree of substitution DScat comprised between about 0.01 and about 0.15, a hydroxyalkyl molar substitution comprised between about 0.1 and about 1 and a weight average molecular weight comprised between about 500,000 g/mol and about 2,000,000 g/mol.

According to another one of the invention embodiments, the cationic polysaccharide derivative of the invention is a cationic galactomannan derivative, for instance a cationic guar derivative, having a cationic degree of substitution DScat comprised between about 0.01 and about 0.40, a hydroxyalkyl molar substitution comprised between about 0.1 and about 1 and a weight average molecular weight comprised between about 2,000 g/mol and about 90,000 g/mol.

According to another one of the invention embodiments, the cationic polysaccharide derivative of the invention is a cationic tamarind gum derivative, for instance a cationic tamarind gum derivative having a cationic degree of substitution DScat ranging from about 0.001 to about 3.

Other Components

The herbicidal compositions of the present invention optionally may further comprise at least one non-auxin herbicide.

The term “non-auxin herbicide” refers to a herbicide having a primary mode of action other than as an auxin herbicide. Representative examples of non-auxin herbicides include acetyl CoA carboxylase (ACCase) inhibitors, acetolactate synthase (ALS) inhibitors, acetohydroxy acid synthase (AHAS) inhibitors, photosystem II inhibitors, photosystem I inhibitors, protoporphyrinogen oxidase (PPO or Protox) inhibitors, carotenoid biosynthesis inhibitors, enolpyruvyl shikimate-3-phosphate (EPSP) synthase inhibitor, glutamine synthetase inhibitor, dihydropteroate synthetase inhibitor, mitosis inhibitors, and nucleic acid inhibitors; salts and esters thereof; racemic mixtures and resolved isomers thereof; and combinations thereof.

According to anyone of the invention embodiments, the herbicidal compositions of the invention further comprise glyphosate or glufosinate, or an agriculturally acceptable salt thereof such as, for example, the ammonium, diammonium, dimethylammonium, monoethanolamine, isopropylamine, and potassium salt thereof.

According to one of the invention embodiments, the herbicidal compositions of the present invention comprise dicamba, or an agriculturally acceptable salt or ester thereof, and glyphosate, or an agriculturally acceptable salt thereof.

According to another one of the invention embodiments, the herbicidal compositions of the present invention comprise 2,4-D, or an agriculturally acceptable salt or ester thereof, and glyphosate, or an agriculturally acceptable salt thereof.

The herbicidal compositions of the present invention optionally may further comprise conventional additives such as surfactants, drift reduction agents, safeners, solubility enhancing agents, thickening agents, flow enhancers, foam-moderating agents, freeze protectants, UV protectants, preservatives, antimicrobials, and/or other additives that are necessary or desirable to improve the performance, crop safety, or handling of the composition.

According to anyone of the invention embodiments, the adjuvant and/or herbicidal composition of the invention comprises less than about 10 ppm of ammonium sulfate, or even no (0 ppm) ammonium sulfate. In this case, buffering and/or water conditioning may be provided by alternative additives, such as for instance dipotassium phosphate or potassium carbonate.

According to one embodiment, in particular when the polysaccharide derivative is a tamarind gum derivative, such as a tamarind seed gum polymer, for instance a hydroxypropyl tamarind, the adjuvant and/or herbicidal composition of the invention does not comprise a combination of dipotassium phosphate and tri-potassium citrate.

According to another embodiment, in particular when the polysaccharide derivative is a tamarind gum derivative, such as a tamarind seed gum polymer, for instance a hydroxypropyl tamarind, the adjuvant and/or herbicidal composition of the invention does not comprise a combination of di-potassium phosphate, potassium nitrate and tri-potassium citrate.

### Herbicidal Composition Embodiments and Component Loading

The herbicidal compositions of the invention can be presented in various forms depending upon the intended use and handling properties desired.

For example, as detailed in US2014128264, the herbicidal compositions of the present invention can be prepared in dry powder form or in liquid form, particularly aqueous solutions or dispersions. The term “aqueous” as used in this application, however, is not intended to exclude the presence of non-aqueous (i.e., organic) solvents as long as water is present. Non-aqueous solutions or dispersions, for instance oil dispersions or dispersions in organic solvents are also within the scope of the present invention.

Among the various composition presentations of the invention are the following:

(a) a ready-to-use herbicidal composition that can be applied to unwanted plants without the need for further dilution with a solvent or other preparation;

(b) a herbicidal composition concentrate that is diluted with a solvent, e.g. water, and optionally combined with other herbicide and non-herbicide materials, prior to application (including, e.g., dry mixes and premixes);

(c) a herbicidal composition application mixture prepared by diluting a herbicidal composition concentrate with a solvent, e.g. water, to form the herbicidal composition application mixture which then can be applied to auxin-susceptible plants;

(d) a herbicidal composition application mixture prepared by combining two or more separate components with a solvent, e.g. water, (e.g., a tank mix) to form the herbicidal composition application mixture which then can be applied to auxin-susceptible plants; and

(e) a herbicidal composition application mixture prepared by introducing separate feed streams to a spraying or application system so that the feed streams are co-mixed to form the herbicidal composition application mixture immediately prior to use.

Suitable amounts, concentrations, and/or mass ratios of the auxin herbicide, polysaccharide derivative as defined according to the invention, and optional non-auxin herbicide will depend to some extent upon whether the composition is a ready-to-use composition, a concentrate to be diluted with a solvent, e.g. water, prior to application (e.g., a “premix”), or a herbicidal composition prepared by combining two or more herbicide components, a solvent (e.g. water), and, optionally, other non-herbicide components (e.g., a “tank mix”).

Typical herbicide loading (recited e.g. in US2014128264) are the following.

Concentrated herbicidal compositions of the present invention typically comprise on an acid equivalent basis (a.e.), for example, from about 120 to about 600 g a.e./L total herbicide loading.

Ready-to-use herbicidal compositions and other herbicidal compositions of the present invention requiring no further processing prior to application (e.g., diluted concentrates, tank mixes, etc.) typically will comprise on an acid equivalent basis (a.e.) from about 0.1 g a.e./L to about 50 g a.e./L total herbicide loading.

In herbicidal compositions of the present invention comprising an auxin herbicide and a non-auxin herbicide, the weight ratio on an acid equivalent basis of the auxin herbicide to the non-auxin herbicide is typically no greater than about 50:1. It may range for instance from about 25:1 to about 3:1.

As for the polysaccharide derivative loading of the herbicidal composition, it generally will depend upon the auxin herbicide loading of the herbicidal composition, the salt form of the auxin herbicide, and the properties of any other components of the herbicidal composition, and will be an amount sufficient to reduce the volatility of the auxin herbicide relative to a reference composition lacking the polysaccharide derivative as defined according to the invention, but otherwise having the same composition. For example, the monoethanolamine and diethanolamine salts of dicamba are less volatile than the dimethylamine and isopropylamine salts of dicamba and the loading required for the less volatile salts may be less than the loading required for the more volatile salts. In addition, the loading of the polysaccharide derivative as defined according to the invention, can vary with the specific combination of auxin herbicide, optional non-auxin herbicide, and polysaccharide derivative as defined according to the invention.

In the herbicidal compositions of the present invention the mass ratio of the auxin herbicide to the polysaccharide derivative as defined according to the invention, is typically no less than about 3:1 and no greater than about 300:1. Representative mass ratios of auxin herbicide acid equivalent (a.e.) to total polysaccharide derivative as defined according to the invention, are, for example, from about 3:1 to about 300:1.

In another aspect, the invention provides methods of controlling the growth of auxin-susceptible plants, wherein the methods comprise applying to the auxin-susceptible plants a herbicidal composition application mixture comprising at least one auxin herbicide; at least one cationic polysaccharide derivative; and, optionally, a non-auxin herbicide; wherein the application mixture exhibits reduced auxin herbicide volatility relative to an otherwise identical application mixture lacking the polysaccharide derivative as defined according to the invention

According to anyone of the invention embodiments, the methods of controlling the growth of auxin-susceptible plants comprise the steps of: (a) preparing an aqueous herbicidal application mixture by diluting with water a herbicidal composition concentrate of any of the herbicidal composition concentrates disclosed in this application; and (b) applying a herbicidally effective amount of the application mixture to the auxin-susceptible plants.

In another aspect, the invention provides methods of controlling off-site movement of an auxin herbicide, wherein the methods comprise contacting the auxin herbicide with a volatility-lowering effective amount of one cationic polysaccharide derivative, prior to application of the auxin herbicide.

Another embodiment of the present invention is directed to methods of counseling an individual regarding the preparation and/or application of an auxin herbicide to auxin-susceptible plants.

Another object of the present invention is to provide an adjuvant which is useful for reducing the volatility and off-target movement of any volatile pesticide, such as for instance trifluralin, pendimethalin or prosulfocarb.

The addition of a sufficient amount of a polysaccharide derivative as defined according to the invention to such volatile pesticides also results in a reduced volatility upon application relative to an otherwise identical composition lacking the polysaccharide derivative as defined according to the invention.

The invention will now be described in further detail by way of the following non limiting examples, wherein the abbreviations have the usual meaning in the art.

### EXAMPLES

1/ Preparation of Dicamba Salt With/Without Adjuvants

Reference solution: “Dicamba DMA 500 g/L a.e. aqueous solution” was prepared by dissolving DMA Dicamba (solid form) into deionised water while stirring (magnetic stirrer) at room temperature (see Table 1).

Solutions with adjuvant: “Dicamba DMA 500 g/L a.e. aqueous solution with adjuvant” were prepared as follows: 0.065 g of adjuvant was slowly added in 9.935 g of reference solution, so as to obtain a solution containing 0.65% wt. of adjuvant. This solution was left under stirring until adjuvant is fully dissolved at room temperature (see Table 2).

TABLE 1
Preparation of Reference solution “Dicamba
DMA 500 g/L a.e. aqueous solution”

| | Weight (g) |
|---|---|
| Dicamba DMA (97%) | 62.079 |
| Water | 54.413 |

TABLE 2
Preparation of solution with adjuvant “Dicamba
DMA 500 g/L a.e. aqueous solution with adjuvant”

| | Weight (g) |
|---|---|
| Dicamba DMA (500 g/L a.e.) | 9.935 |
| Adjuvant | 0.065 |

2/ Volatility Assessment

With a 3 ml plastic pipette, 2 g of aqueous solution (“Dicamba DMA 500 g/L a.e. aqueous solution” or “Dicamba DMA 500 g/L a.e. aqueous solution with adjuvant” as prepared in 1/) were sampled and deposited as a series of droplets uniformly distributed, having a diameter between 2 and 10 mm, onto the aluminum plate (10 cm diameter) of a halogen moisture analyzer Mettler Toledo HX 204. An isotherm program was immediately set-up at 75° C. during 5 hours and the solution weight loss % (wt. loss %) was recorded over this time period. The volatility extent was assessed by calculating the weight loss % per hour defined as the slope of the curve over the time period between 2 and 5 hours. Each experiment was repeated a minimum of 3 times and the standard deviation (SD) was calculated.

Efficiency of volatilization decrease has been defined by the following equation and allows comparing the ability of the different adjuvants to decrease volatility (see Table 3)

$$\frac{\begin{matrix}Slope 2 \text{-} 5 h {( \% / h )}_{Dicamba DMA 500 g / L aqueous solution} - \\ Slope 2 \text{-} 5 {h ( \% / h )}_{Dicamba DMA 500 g / L aqueous solution with adjuvant}\end{matrix}}{Slope 2 \text{-} 5 h {( \% / h )}_{Dicamba DMA 500 g / L aqueous solution}}$$

TABLE 3
Comparison of different adjuvants. (SD: Standard Deviation)

| | Volatility | | |
|---|---|---|---|
| | extent | | |
| | Slope 2-5 h | | |
| | (wt. % | | Efficiency of |
| | loss per | | volatilization |
| Formulations | hour) | SD | decrease |
| Reference solution (Dicamba | 0.340 | 0.021 | — |
| DMA 500 g/L a.e. aqueous | | | |
| solution) | | | |
| Dicamba DMA 500 g/L a.e. | 0.250 | 0.020 | 26.5% |
| aqueous solution with 0.65% of | | | |
| polysaccharide derivative 1^{a)} | | | |
| Dicamba DMA 500 g/L a.e. | 0.260 | 0.015 | 23.5% |
| aqueous solution with 0.65% of | | | |
| polysaccharide derivative 2^{b} | | | |
| Dicamba DMA 500 g/L a.e. | 0.260 | 0.013 | 23.5% |
| aqueous solution with 0.65% of | | | |
| polysaccharide derivative 3^{c} | | | |
| Dicamba DMA 500 g/L a.e. | 0.270 | 0.015 | 20.6% |
| aqueous solution with 0.65% of | | | |
| polysaccharide derivative 4^{d} | | | |
| Dicamba DMA 500 g/L a.e. | 0.280 | 0.006 | 17.7% |
| aqueous solution with 0.65% of | | | |
| polysaccharide derivative 5^{e} | | | |
| Comparative solution: Dicamba | 0.310 | 0.015 | 8.8% |
| DMA 500 g/L a.e. aqueous | | | |
| solution with 0.65% of Lupasol | | | |
| P | | | |

^{a)}Guar Hydroxypropyl trimonium chloride having a molecular weight of about 500,000 g/mol and having a cationic degree of substitution of about 0.3, available from Solvay
^{b}Hydroxypropyl guar hydroxypropyltrimonium chloride having a molecular weight of about 1,200,000 g/mol, a cationic degree of substitution of about 0.1 and a hydroxyalkyl molar substitution of about 0.5, available from Solvay;
^{c}Guar Hydroxypropyl trimonium chloride having a molecular weight of about 1,200,000 and having a cationic degree of substitution of about 0.1, available from Solvay
^{d}Guar Hydroxypropyl trimonium chloride having a molecular weight of about 500,000 g/mol and having a cationic degree of substitution of about 0.1, available from Solvay
^{e}Guar Hydroxypropyl trimonium chloride having a molecular weight of about 2,000,000 g/mol and having a cationic degree of substitution of about 0.2, available from Solvay

All these results demonstrate that auxin herbicide compositions containing, as adjuvant, a polysaccharide derivative of the invention exhibit a lower volatility compared to a control composition that does not include such an adjuvant.

These results also demonstrate that auxin herbicide compositions containing, as adjuvant, a polysaccharide derivative of the invention exhibit a lower volatility compared to a comparative composition containing Lupasol P as adjuvant.

Lupasol P is a prior art polyethylenimine supplied by BASF that has already been described as adjuvant in auxin herbicide compositions, and is thus considered as a benchmark.

The experimental results provided herewith illustrate that the polysaccharide of the invention are thus useful adjuvants to reduce volatility and off site movement of an auxin herbicide.

II. The relative volatility of DMA salt of dicamba contained in aqueous formulations was also measured in bottle experiments (24 h, nitrogen flow, room temperature).

1/ Preparation of Diluted Aqueous Formulations of Dicamba Salt With/Without Adjuvants

Concentrated solution of DMA salt of Dicamba (500 g a.e./L) was prepared by dissolution of 26.522 g of solid DMA Dicamba salt slowly added in 23.471 g of distilled water under magnetic stirring. 4.680 g of concentrated solution of DMA salt of Dicamba were diluted into 95.320 g of distillated water in order to reach 2% wt. a.e. (i.e. 2.4% wt. DMA Dicamba), under magnetic stirring.

In the cases where adjuvants were added: 0.200 g of adjuvants was slowly added in 99.8 g of 2% wt. a.e. (i.e. 2.4% wt. DMA Dicamba) solution under magnetic stirring (600 rpm) and the resulting solution was left under stirring during few hours (to reach complete solubilization of adjuvants).

2/ Volatilization System

2.1 Volatilization Chamber (Glass Bottle)

A 1 liter laboratory bottle (borosilicate glass) equipped with trapping system was used to assess volatilization. Dicamba contained in the vapor phase was collected in water phase (trapping system) prior to analysis.

Prior to use, 1 liter bottle and tubbing were washed two times using ultra-pure water/acetone and dried with pure nitrogen.

The 1 liter bottle included inlet and outlet gas (via the cup). Inlet and outlet connections were made using ¼ inch PTFE tube, ¼ inch BollaTM fitting and ¼ inch double ferrule in PTFE. Inlet gas was injected at the bottom of the bottle while the outlet gas at the top.

5 g of diluted aqueous formulation of DMA Dicamba (2% wt. a.e.) were introduced at the bottom of the glass bottle using a 3 mL standard disposable plastic transfer pipette.

Once the experiment started, the bottle remained undisturbed for 24 h under controlled conditions.

2.2 Controlled Conditions (Flow Control)

The gas flow was composed of dry nitrogen. The flow is controlled with a mass flow controller at 75 standard liters per hour.

Bottle is left at room temperature (range 19-22° C.) during 24 h. During this period, Dicamba present in the gas phase was captured.

2.3 Capture System

The capture system was composed of one glass flask connected to an 8 ball-column (glass) using a dip glass tube. The flask was filled with 30 mL of ultra-pure water and phosphoric acid in order to reach pH 1.8. This acidic liquid phase trapped the volatilized Dicamba thanks to high surface of exchange between gas and liquid.

3/ Volatility Assessment

3.1 Analytical Method

The acidic liquid phase (20-30 mL) was recovered and injected to HPLC column (Zorbax Sb-Aq (4.6×50 mm, 50 microns)). Pumping was done through a 6 port valve (1-2).

Then, the 6 port valve was turned in 1-6 in order to connect the column to the diode strip detector.

The mobile phase gradient consisted of 1.2% of phosphoric acid in water (pH 1.8) and acetonitrile. The mobile phase started at 85% water-15% Acetonitrile during 10 minutes, 60% water-40% Acetonitrile during 14 minutes and 100% water during 15 minutes. 3.2 Results

The results show that the volatility of formulations containing 2 wt % a.e. DMA Dicamba is of 1.36±0.08 ng/L.

A diminution of volatility of an auxin herbicide of the present invention is systematically observed. For example, the result shows that the volatility of the formulation containing 2 wt % a.e. DMA Dicamba with 0.2% wt. of adjuvant (b) is of 0.05±0.02 ng/L.

“ng/L air” refers to the dicamba concentration in the gas phase.

These results demonstrate that auxin herbicide compositions containing, as adjuvant, a polysaccharide derivative of the invention exhibit a lower volatility compared to a composition that does not include such an adjuvant.

The experimental results provided herewith illustrate that the polysaccharide of the invention are thus useful adjuvants to reduce volatility and off site movement of an auxin herbicide.

1. A method of reducing the volatility of an auxin herbicide, the method comprising contacting the auxin herbicide with an effective amount of at least one volatility-lowering cationic polysaccharide derivative.

2. The method of claim 1, wherein the auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-quinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

3. The method of claim 1, wherein the auxin herbicide is dicamba, or an agriculturally acceptable salt or ester thereof.

4. The method according to claim 1, wherein said cationic polysaccharide derivative has a cationic degree of substitution DScat ranging from about 0.001 to about 3.

5. The method according to claim 1, wherein said cationic polysaccharide derivative has a weight average molecular weight ranging from about 2,000 to about 3,000,000 g/mol.

6. The method according to claim 1, wherein said cationic polysaccharide derivative is a cationic galactomannan derivative.

7. A method of reducing off-site movement of an auxin herbicide following application to the foliage of auxin-susceptible plants of a herbicidal mixture comprising an auxin herbicide, the method comprising:
applying a herbicidal application mixture comprising an auxin herbicide, at least one cationic polysaccharide derivative, and a solvant to the foliage of the auxin-susceptible plants.

8. The method of claim 7, wherein said auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-guinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

9. The method of claim 7, wherein said cationic polysaccharide derivative is a cationic galactomannan derivative.

10. An herbicidal composition comprising:
at least one auxin herbicide, and
at least one cationic polysaccharide derivative.

11. The composition of claim 10, wherein said auxin herbicide is selected in the group consisting of 2,4-D (2,4-dichlorophenoxyacetic acid), 2,4-DB (4-(2,4-dichlorophenoxy)butanoic acid), dichloroprop (2-(2,4-dichlorophenoxy)propanoic acid), MCPA ((4-chloro-2-methylphenoxy)acetic acid), MCPB (4-(4-chloro-2-methylphenoxy)butanoic acid), aminopyralid (4-amino-3,6-dichloro-2-pyridinecarboxylic acid), clopyralid (3,6-dichloro-2-pyridinecarboxylic acid), fluoroxypyr ([(4-amino-3,5-dichloro-6-fluoro-2-pyridinyl)oxy]acetic acid), triclopyr ([(3,5,6-trichloro-2-pyridinyl)oxy]acetic acid), diclopyr, mecoprop (2-(4-chloro-2-methylphenoxy)propanoic acid) and mecoprop-P, dicamba (3,6-dichloro-2-methoxybenzoic acid), picloram (4-amino-3,5,6-trichloro-2-pyridinecarboxylic acid), quinclorac (3,7-dichloro-8-guinolinecarboxylic acid), aminocyclopyrachlor (6-amino-5-chloro-2-cyclopropyl-4-pyrimidinecarboxylic acid), agriculturally acceptable salts of any of these herbicides, racemic mixtures and resolved isomers thereof, and mixtures thereof.

12. The composition according to claim 10, wherein said cationic polysaccharide derivative is a cationic galactomannan derivative.

13. The composition according to claim 10, comprising a mass ratio of the auxin herbicide acid equivalent (a.e.) to total polysaccharide derivative of from about 3:1 to about 300:1.

14. A process for preparing a diluted auxin herbicide spray formulation exhibiting reduced off-site movement of said auxin herbicide comprising introducing a cationic polysaccharide derivative to said diluted agrochemical spray formulation.

15. A method for treating an agricultural field comprising spraying the field with the diluted auxin herbicide spray formulation of claim 14.

16. The method according to claim 3, wherein the dicamba is selected from the group consisting of dicamba sodium salt, dicamba potassium salt, dicamba monoethanolamine salt, dicamba diethanolamine salt, dicamba isopropylamine salt, dicamba diglycolamine salt, dicamba N,N-bis-(3-aminopropyl)methylamine salt, dicamba dimethylamine salt, or mixtures thereof.

17. The method according to claim 6, wherein the cationic polysaccharide derivative is a cationic guar derivative.
